(19) United States
(12) Patent Application Publication
(10) Pub. No.: US 2026/0313411 A1
(43) Pub. Date: Oct. 8, 2026

(54) TRACKING CHANGES IN ELECTRONIC LABEL DISPLAY LOCATION AND ELECTRONIC LABEL RADIO LOCATION USING RADIO FREQUENCY MEASUREMENTS AND CAMERA MEASUREMENTS

(71) Applicant: QUALCOMM Incorporated, San Diego, CA (US)

(72) Inventors: Varun Amar REDDY, San Diego, CA (US); Amit GOEL, San Diego, CA (US); Sony AKKARAKARAN, Poway, CA (US)

(21) Appl. No.: 19/630,344

(22) Filed: Mar. 26, 2026

Related U.S. Application Data
(60) Provisional application No. 63/783,414, filed on Apr. 4, 2025.

(51) Int. Cl. H04W 24/08; H04W 24/10

(52) U.S. Cl. CPC H04W 24/08; H04W 24/10

(57) ABSTRACT

In some aspects, a method of positioning performed by a server includes receiving a plurality of radio frequency (RF) measurements of a plurality of beacon signals transmitted by an electronic label radio; determining whether a statistic of a set of RF measurements of the plurality of RF measurements received over a measurement window varies from an expected value of the statistic by more than a threshold; and performing one or more validation operations based on a determination that the statistic of the set of RF measurements received over the measurement window varies from the expected value of the statistic by more than the threshold.

### CROSS-REFERENCE TO RELATED APPLICATIONS

The present application for patent claims the benefit of U.S. Provisional Application No. 63/783,414, entitled “TRACKING CHANGES IN ELECTRONIC SHELF LABEL (ESL) DISPLAY LOCATION AND ESL RADIO LOCATION USING RADIO FREQUENCY MEASUREMENTS AND CAMERA MEASUREMENTS,” filed Apr. 4, 2025, assigned to the assignee hereof, and expressly incorporated herein by reference in its entirety.

### BACKGROUND OF THE DISCLOSURE

### 1. Field of the Disclosure

Aspects of the disclosure relate generally to wireless technologies.

### 2. Description of the Related Art

Electronic labels, such as electronic shelf labels (ESLs), are used by retailers for displaying product pricing or other product information to consumers. Electronic labels typically use electronic paper (e-paper) or liquid crystal display (LCD) to display the current information. E-paper (also referred to as e-ink) is widely used for electronic labels, as it provides a sharp display and supports full graphic imaging while only needing power during updates and no power to retain an image.

Electronic labels are increasingly being integrated with existing retail technologies, such as electronic article surveillance, digital signage, and people counters. For example, retailers can upload a floor plan of the sales area into the electronic label management software. Consumers can then be tracked (in real time) through a network of people-counting devices, or via their personal BLUETOOTH® devices, in order to determine their position within the store at all times. This allows an individual customer to receive targeted, customized marketing initiatives, such as discounts, individual pricing, etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of positioning performed by a server includes receiving a plurality of radio frequency (RF) measurements of a plurality of beacon signals transmitted by an electronic label radio; determining whether a statistic of a set of RF measurements of the plurality of RF measurements received over a measurement window varies from an expected value of the statistic by more than a threshold; and performing one or more validation operations based on a determination that the statistic of the set of RF measurements received over the measurement window varies from the expected value of the statistic by more than the threshold.

In an aspect, a method of positioning performed by a server includes receiving, from a camera system, one or more images of an electronic label display displaying one or more distinct visual indications; determining whether a location of the electronic label display estimated based on the one or more images varies from an expected location of the electronic label display by more than a threshold; and performing one or more validation operations based on a determination that the location of the electronic label display estimated based on the one or more images varies from the expected location of the electronic label display by more than the threshold.

In an aspect, a server includes one or more memories; one or more transceivers; and one or more processors communicatively coupled to the one or more memories and the one or more transceivers, the one or more processors, either alone or in combination, configured to: receive, via the one or more transceivers, a plurality of radio frequency (RF) measurements of a plurality of beacon signals transmitted by an electronic label radio; determine whether a statistic of a set of RF measurements of the plurality of RF measurements received over a measurement window varies from an expected value of the statistic by more than a threshold; and perform one or more validation operations based on a determination that the statistic of the set of RF measurements received over the measurement window varies from the expected value of the statistic by more than the threshold.

In an aspect, a server includes one or more memories; one or more transceivers; and one or more processors communicatively coupled to the one or more memories and the one or more transceivers, the one or more processors, either alone or in combination, configured to: receive, via the one or more transceivers, from a camera system, one or more images of an electronic label display displaying one or more distinct visual indications; determine whether a location of the electronic label display estimated based on the one or more images varies from an expected location of the electronic label display by more than a threshold; and perform one or more validation operations based on a determination that the location of the electronic label display estimated based on the one or more images varies from the expected location of the electronic label display by more than the threshold.

In an aspect, a server includes means for receiving a plurality of radio frequency (RF) measurements of a plurality of beacon signals transmitted by an electronic label radio; means for determining whether a statistic of a set of RF measurements of the plurality of RF measurements received over a measurement window varies from an expected value of the statistic by more than a threshold; and means for performing one or more validation operations based on a determination that the statistic of the set of RF measurements received over the measurement window varies from the expected value of the statistic by more than the threshold.

In an aspect, a server includes means for receiving, from a camera system, one or more images of an electronic label display displaying one or more distinct visual indications; means for determining whether a location of the electronic label display estimated based on the one or more images varies from an expected location of the electronic label display by more than a threshold; and means for performing one or more validation operations based on a determination that the location of the electronic label display estimated based on the one or more images varies from the expected location of the electronic label display by more than the threshold.

In an aspect, a non-transitory computer-readable medium stores computer-executable instructions that, when executed by a server, cause the server to: receive a plurality of radio frequency (RF) measurements of a plurality of beacon signals transmitted by an electronic label radio; determine whether a statistic of a set of RF measurements of the plurality of RF measurements received over a measurement window varies from an expected value of the statistic by more than a threshold; and perform one or more validation operations based on a determination that the statistic of the set of RF measurements received over the measurement window varies from the expected value of the statistic by more than the threshold.

In an aspect, a non-transitory computer-readable medium stores computer-executable instructions that, when executed by a server, cause the server to: receive, from a camera system, one or more images of an electronic label display displaying one or more distinct visual indications; determine whether a location of the electronic label display estimated based on the one or more images varies from an expected location of the electronic label display by more than a threshold; and perform one or more validation operations based on a determination that the location of the electronic label display estimated based on the one or more images varies from the expected location of the electronic label display by more than the threshold.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example electronic label system, according to aspects of the disclosure.

FIG. 2 illustrates example components of an example electronic label, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 is a diagram illustrating an example electronic label deployment scenario, according to aspects of the disclosure.

FIG. 5 is a diagram illustrating an example positioning scenario using a weighted centroid algorithm, according to aspects of the disclosure.

FIG. 6 illustrates various aspects motivating the techniques described herein.

FIG. 7 illustrates an example BLUETOOTH® Low Energy (BLE) generic attribute profile (GATT) procedure, according to aspects of the disclosure.

FIG. 8 illustrates an example electronic label periodic advertising with responses (PAWR) scheme, according to aspects of the disclosure.

FIG. 9 is a diagram illustrating an example scenario of using radio frequency (RF) measurements to track electronic label radio locations, according to aspects of the disclosure.

FIG. 10 is a diagram illustrating an example scenario of using RF measurements to track electronic label radio locations, according to aspects of the disclosure.

FIG. 11 illustrates an example method of positioning, according to aspects of the disclosure.

FIG. 12 is a diagram illustrating an example scenario of using camera infrastructure to track electronic label display locations, according to aspects of the disclosure.

FIG. 13 is a diagram illustrating an example scenario of multiple electronic labels simultaneously displaying a visual indication, according to aspects of the disclosure.

FIG. 14 illustrates an example method of positioning, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to electronic label device deployments, such as electronic shelf label (ESL) deployments. Some aspects more specifically relate to tracking changes in electronic label locations using radio frequency (RF) and camera measurements. In some examples, the disclosure provides a method of tracking electronic label locations by integrating RF measurements and camera measurements, providing solutions that use RF measurements between electronic label radios and access points (APs) for sub-meter accuracy through the periodic advertising with responses (PAWR) protocol, and employing camera measurements for additional location verification of electronic labels.

Particular aspects of the subject matter described in this disclosure can be implemented to realize one or more of the following potential advantages. In some examples, by using one or both of RF measurements and camera measurements, the described techniques can be used to ensure that electronic labels remain in their intended positions, thereby maintaining accurate product information display and improving positioning accuracy in retail environments, and enhancing customer experience while considering potential disadvantages, such as high power consumption and accuracy issues due to environmental changes.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof.

Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

Electronic label displays (or electronic display devices), such as electronic shelf labels (ESLs), are used by retailers for displaying product pricing or other product information to consumers. Electronic labels typically use electronic paper (e-paper) or liquid crystal display (LCD) to display the current information. E-paper (also referred to as e-ink) is widely used for electronic labels, as it provides a sharp display and supports full graphic imaging while only needing power during updates and no power to retain an image, thereby significantly reducing power consumption.

Electronic labels are increasingly being integrated with existing retail technologies, such as electronic article surveillance, digital signage, and people counters. For example, retailers can upload a floor plan of the sales area into the electronic label management software. Consumers can then be tracked (in real time) through a network of people-counting devices, or via their personal BLUETOOTH® devices, in order to determine their position within the store at all times. This allows an individual customer to receive targeted, customized marketing initiatives, such as discounts, individual pricing, etc.

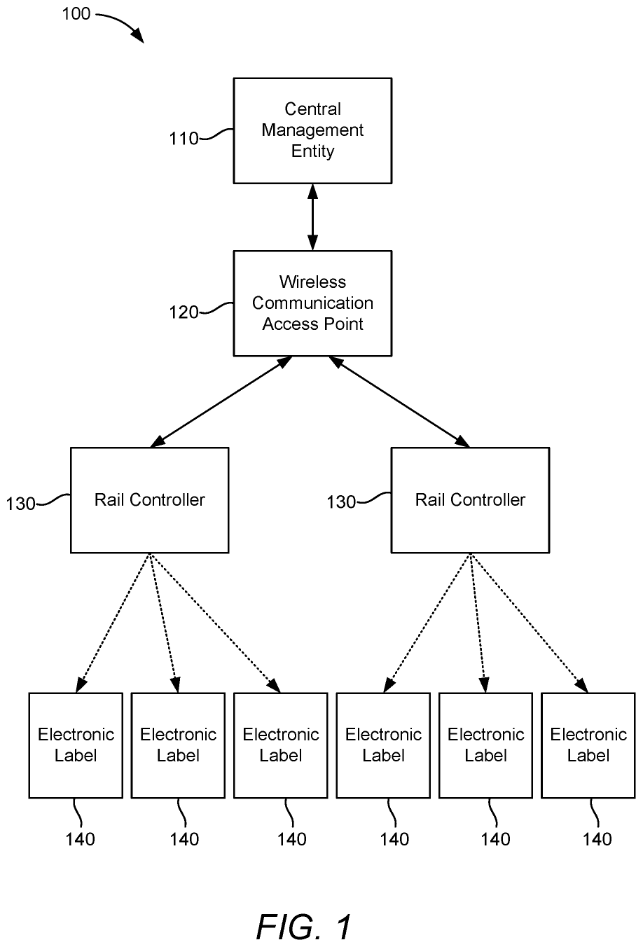

FIG. 1 illustrates an example electronic label system 100, according to aspects of the disclosure. An electronic label system generally includes three components: label management software (e.g., running on a central management entity 110, such as a local server at the retail location or a cloud-based server), one or more wireless communication access points 120 (e.g., Wi-Fi® access points), one or more rail controllers 130, and one or more (usually many) electronic labels, illustrated as electronic labels 140. The label management software is responsible for the configuration of the system, configuration of the properties of the electronic labels 140 themselves, and storing the database of information to be displayed by the electronic labels 140. The software mainly covers the network management, file systems, and transmission of data. It also processes and packs the data to be displayed into packets of information. The data packets are then sent to one or more wireless communication access points 120 via a wireless network (e.g., Wi-Fi®) for distribution to the electronic labels 140 via the one or more rail controllers 130.

A wireless communication access point 120 is responsible for the stability and reliability of transmissions from the label management software (on the central management entity 110) to the electronic labels 140. There may be multiple wireless communication access points 120 deployed in a single retail location based on the size of the space and/or the number of electronic labels 140 deployed.

A wireless communication access point 120 communicates with one or more rail controllers 130 via a short-range wireless communications protocol, such as BLUETOOTH® Low Energy (BLE). A rail controller 130 may therefore include a BLE radio (or other short-range wireless communications protocol radio). A rail controller 130 may be powered by a battery (e.g., a lithium-ion battery) or a wired connection. A rail controller 130 is coupled to, or integrated into, a rail to which multiple electronic labels 140 can be “clipped” or otherwise attached. Once clipped to the rail, each electronic label 140 has a wired connection to the rail controller 130 (e.g., via a three-wire bus for power, ground, and data).

An electronic label 140 functions as a receiver from the wireless communication access point 120 (via the rail controller 130) to display the information configured from the label management software. The electronic label 140 then acts based on the instructions that were provided in the data packets from the label management software. An electronic label 140 includes a display and optionally a camera. Electronic labels 140 generally do not include batteries, as they are typically powered by the rail to which they are attached. However, in some cases, an electronic label 140 may be powered by a coin-cell battery, which may provide an operational life of eight to nine years. In some cases, an electronic label 140 may not have a short-range wireless communications radio (e.g., a BLE radio), as it receives data from the wireless communication access point 120 via the wired rail connection to the rail controller 130.

An electronic label application programming interface (API) is included in the current BLUETOOTH® specification and permits a 7-bit group identifier of 8-bit unique electronic label identifiers, allowing for a total of 32,640 electronic labels 140 to be allocated for one wireless communication access point 120. With those constraints, multiple wireless communication access points 120 may be needed to cover a typical grocery store electronic label application.

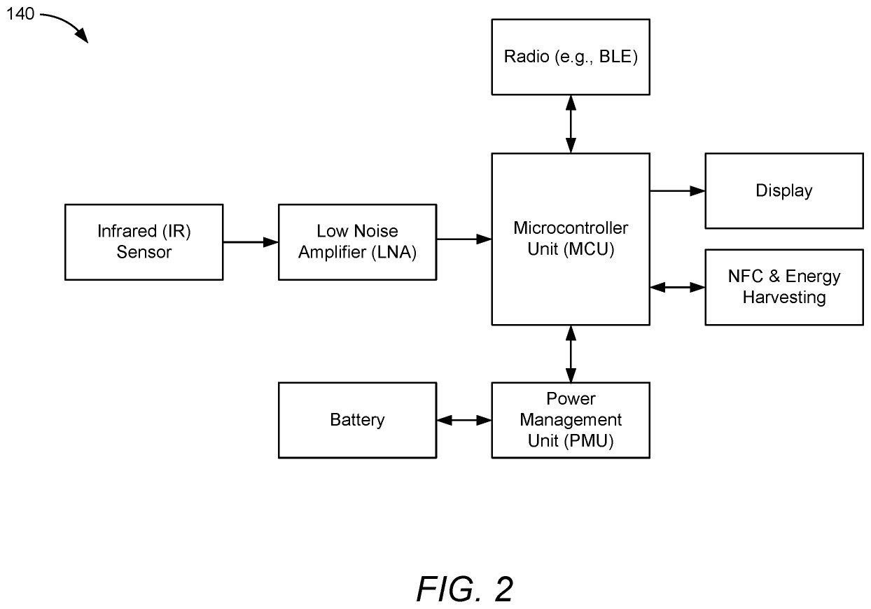

FIG. 2 illustrates example components of an example electronic label, such as electronic label 140, according to aspects of the disclosure. Note that in some cases, rather than an electronic label 140 having its own wireless radio (e.g., a BLE radio) as shown in FIG. 2, multiple electronic labels 140 may be attached (e.g., clipped) to a rail attached to a retail shelf. In this case, the rail (specifically a rail controller 130) contains the short-range wireless communications radio and the electronic labels 140 have just the display. The rail controller 130 in the rail communicates locally to the clipped-on electronic labels 140 over a wired protocol (the act of clipping on connects the electronic labels 140 to the wires of the rail controller 130). As such, an electronic label 140 itself may not have a radio but may connect locally to one (i.e., the rail controller 130). Note that in either case, the radio may also be referred to as a transceiver.

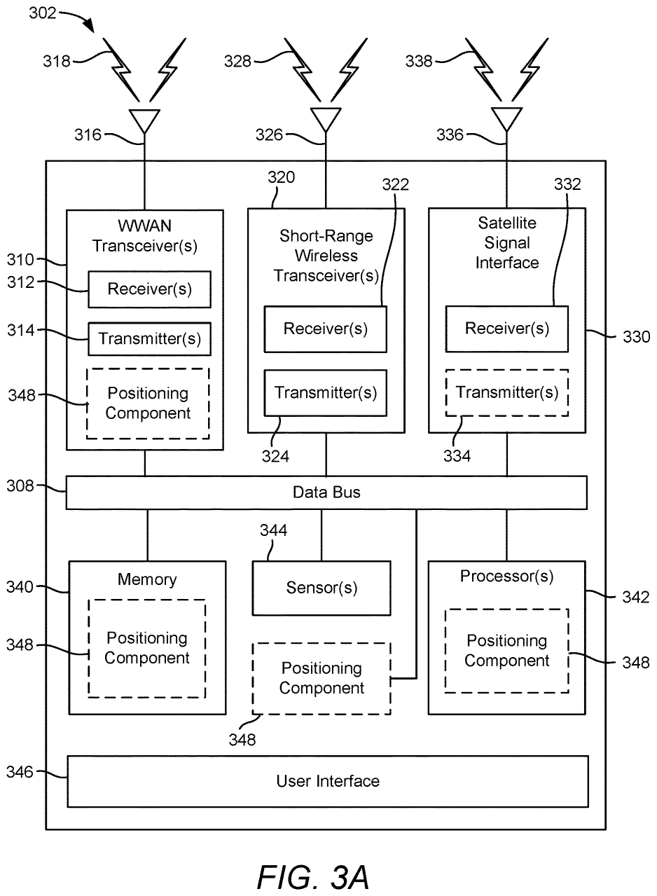

FIGS. 3A, 3B, and 3C illustrate several example components (represented by corresponding blocks) that may be incorporated into a UE 302 (which may correspond to any of the UEs described herein), a base station 304 (which may correspond to any of the base stations or access points described herein), and a network entity 306 (which may correspond to or embody any of the network functions described herein, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system.

For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi®, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest.

The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be Wi-Fi® transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal interfaces 330 and 370, which each include one or more satellite signal receivers 332 and 372, respectively, and may optionally include one or more satellite signal transmitters 334 and 374, respectively. In some cases, the base station 304 may be a terrestrial base station that may communicate with space vehicles (e.g., space vehicles 112) via the satellite signal interface 370. In other cases, the base station 304 may be a space vehicle (or other non-terrestrial entity) that uses the satellite signal interface 370 to communicate with terrestrial networks and/or other space vehicles.

The satellite signal receivers 332 and 372 may be connected to one or more antennas 336 and 376, respectively, and may provide means for receiving and/or measuring satellite positioning/communication signals 338 and 378, respectively. Where the satellite signal receiver(s) 332 and 372 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS) signals, etc. Where the satellite signal receiver(s) 332 and 372 are non-terrestrial network (NTN) receivers, the satellite positioning/communication signals 338 and 378 may be communication signals (e.g., carrying control and/or user data) originating from a 5G network. The satellite signal receiver(s) 332 and 372 may comprise any suitable hardware and/or software for receiving and processing satellite positioning/communication signals 338 and 378, respectively. The satellite signal receiver(s) 332 and 372 may request information and operations as appropriate from the other systems, and, at least in some cases, perform calculations to determine locations of the UE 302 and the base station 304, respectively, using measurements obtained by any suitable satellite positioning system algorithm.

The optional satellite signal transmitter(s) 334 and 374, when present, may be connected to the one or more antennas 336 and 376, respectively, and may provide means for transmitting satellite positioning/communication signals 338 and 378, respectively. Where the satellite signal transmitter(s) 374 are satellite positioning system transmitters, the satellite positioning/communication signals 378 may be GPS signals, GLONASS® signals, Galileo signals, Beidou signals, NAVIC, QZSS signals, etc. Where the satellite signal transmitter(s) 334 and 374 are NTN transmitters, the satellite positioning/communication signals 338 and 378 may be communication signals (e.g., carrying control and/or user data) originating from a 5G network. The satellite signal transmitter(s) 334 and 374 may comprise any suitable hardware and/or software for transmitting satellite positioning/communication signals 338 and 378, respectively. The satellite signal transmitter(s) 334 and 374 may request information and operations as appropriate from the other systems.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 342, 384, and 394, respectively, for providing functionality relating to, for example, wireless communication, and for providing other processing functionality. The processors 342, 384, and 394 may therefore provide means for processing, such as means for determining, means for calculating, means for receiving, means for transmitting, means for indicating, etc. In an aspect, the processors 342, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning components 348, 388, and 398, respectively. The positioning components 348, 388, and 398 may be hardware circuits that are part of or coupled to the processors 342, 384, and 394, respectively, and are configured to cause the UE 302, the base station 304, and the network entity 306 to perform the functionality described herein. In other aspects, the positioning components 348, 388, and 398 may be external to the processors 342, 384, and 394 (e.g., part of a modem processing system, integrated with another processing system, etc.). Alternatively, the positioning component 348, 388, and 398 may be memory modules stored in the memories 340, 386, and 396, respectively, that, when executed by the processors 342, 384, and 394 (or a modem processing system, another processing system, etc.), cause the UE 302, the base station 304, and the network entity 306 to perform the functionality described herein. FIG. 3A illustrates possible locations of the positioning component 348, which may be, for example, part of the one or more WWAN transceivers 310, the memory 340, the one or more processors 342, or any combination thereof, or may be a standalone component. FIG. 3B illustrates possible locations of the positioning component 388, which may be, for example, part of the one or more WWAN transceivers 350, the memory 386, the one or more processors 384, or any combination thereof, or may be a standalone component. FIG. 3C illustrates possible locations of the positioning component 398, which may be, for example, part of the one or more network transceivers 390, the memory 396, the one or more processors 394, or any combination thereof, or may be a standalone component.

The UE 302 may include one or more sensors 344 coupled to the one or more processors 342 to provide means for sensing or detecting movement and/or orientation information that is independent of motion data derived from signals received by the one or more WWAN transceivers 310, the one or more short-range wireless transceivers 320, and/or the satellite signal interface 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer protocol date units (PDUs), error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 342. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 342, which implements Layer-3 (L3) and Layer-2 (L2) functionality.

In the downlink, the one or more processors 342 provides demultiplexing between transport and logical channels, packet reassembly, deciphering, header decompression, and control signal processing to recover IP packets from the core network. The one or more processors 342 are also responsible for error detection.

Similar to the functionality described in connection with the downlink transmission by the base station 304, the one or more processors 342 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or personal computer (PC) or laptop may have Wi-Fi® and/or BLUETOOTH® capability without cellular capability), or may omit the short-range wireless transceiver(s) 320 (e.g., cellular-only, etc.), or may omit the satellite signal interface 330, or may omit the sensor(s) 344, and so on. In another example, in case of FIG. 3B, a particular implementation of the base station 304 may omit the WWAN transceiver(s) 350 (e.g., a Wi-Fi® “hotspot” access point without cellular capability), or may omit the short-range wireless transceiver(s) 360 (e.g., cellular-only, etc.), or may omit the satellite signal interface 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 308, 382, and 392, respectively. In an aspect, the data buses 308, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 308, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 342, 384, 394, the transceivers 310, 320, 350, and 360, the memories 340, 386, and 396, the positioning component 348, 388, and 398, etc.

In some designs, the network entity 306 may be implemented as a core network component. In other designs, the network entity 306 may be distinct from a network operator or operation of the cellular network infrastructure. For example, the network entity 306 may be a component of a private network that may be configured to communicate with the ULE 302 via the base station 304 or independently from the base station 304 (e.g., over a non-cellular communication link, such as Wi-Fi®).

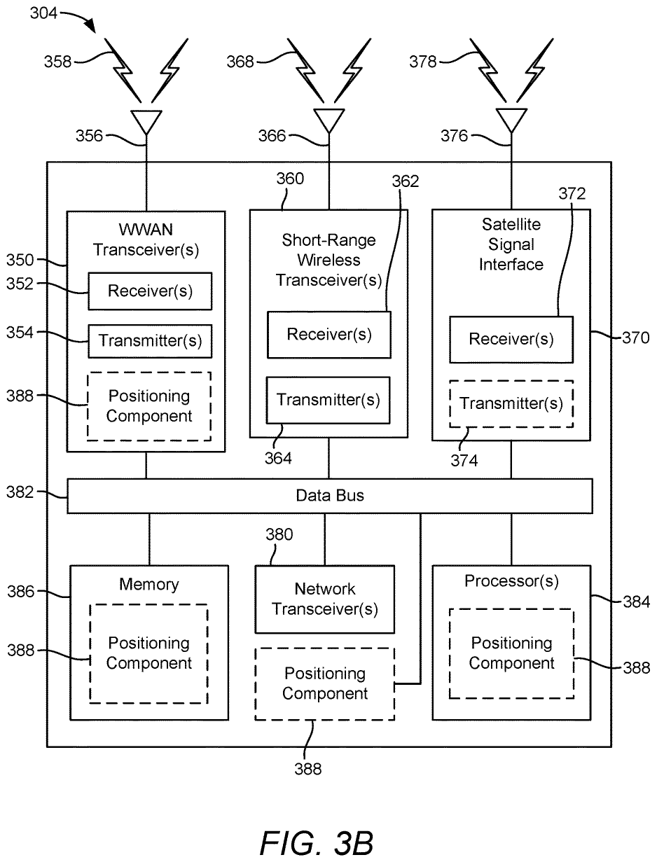

FIG. 4 is a diagram 400 illustrating an example electronic label deployment scenario, according to aspects of the disclosure. Specifically, FIG. 4 illustrates a top view of a scenario where electronic labels (e.g., electronic labels 140) are deployed on both sides of two aisles of shelves in a retail establishment, warehouse, or the like. In the example of FIG. 4, groups of three electronic labels are connected to a rail controller (e.g., a rail controller 130 utilizing, for example, a BLE radio) and the rail controllers are spaced 1 m to 2 m apart. However, as will be appreciated, this is merely an example configuration and there may be more or fewer electronic labels per rail controller spaced closer or further apart.

In some cases, the electronic labels may not be equipped with short-range wireless communications radios (e.g., BLE radios), and instead, the rail controller may include the short-range wireless communications radio for the three electronic labels connected to it. In either case, the radio associated with an electronic label (whether a component of the electronic label of the rail controller to which the electronic label is connected) may be referred to as an “electronic label radio.” Note that, as an electronic label may include a radio (see, e.g., FIG. 2), the term “electronic label” may also refer to the electronic label radio. Where the radio is explicitly not included in the electronic label, the electronic label may be referred to as an “electronic label display.”

Indoor positioning based on BLE beaconing from electronic labels is being developed for retail and warehouse applications. In general, the location of a target device (e.g., an energy harvesting tag (eTag)) is determined based on signal strength measurements (e.g., received signal strength indicator (RSSI)) of beacon signals transmitted by multiple electronic labels. Trilateration using RSSI has been observed to be highly unreliable, as the RSSI is very susceptible to attenuation, which in turn leads to poor range estimation accuracy. Instead, the weighted centroid algorithm is considered to be much more robust to attenuation and non-line-of-sight (NLOS) effects.

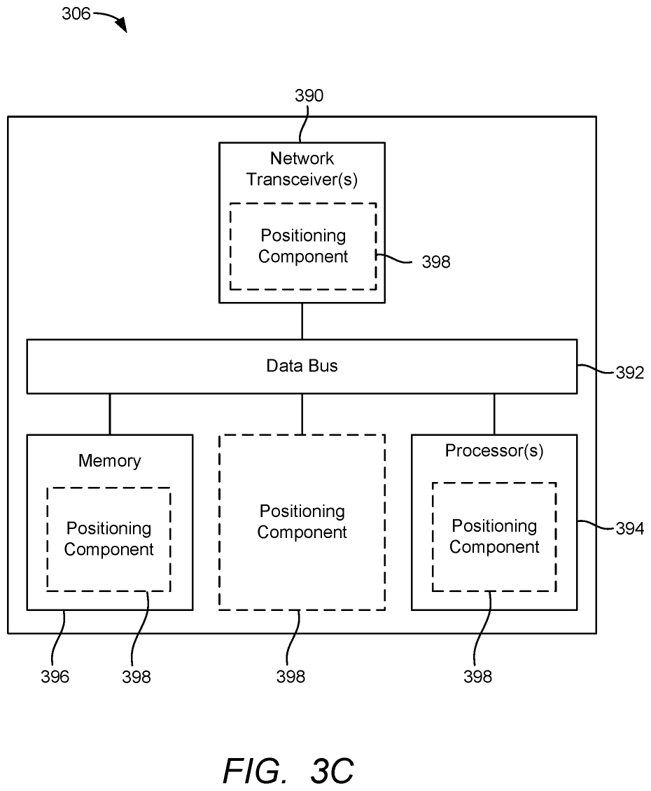

FIG. 5 is a diagram 500 illustrating an example positioning scenario using a weighted centroid algorithm, according to aspects of the disclosure. In the example of FIG. 5, measurements of the beacon signals transmitted by three electronic label radios (labeled “EL1,” “EL2,” and “EL3”) are used to determine a location of a target device. For a given target device beacon transmission, let r₁≥r₂≥ . . . r_{M} denote the RSSI values of the beacon as measured by M electronic label radios (in descending order). The target device position estimate is then given by the weighted average of the electronic label radio positions, where the weights are a function of the RSSI values:

$$\hat{P} = \frac{{\sum }_{k = 1}^{N} {w}_{k} \cdot {P}_{k}}{{\sum }_{k = 1}^{N} {w}_{k}}$$

In the above equations, N<M is the maximum number of electronic label radios that are used in the computation, and wₖ is an exponential function (based on a value A) of the RSSI values. N and λ are empirical terms that may be preset to some desired value. The weights may be proportional to the RSSIs. That is, the weight assigned to the k^{th} electronic label radio is proportional to the signal strength measured by that electronic label radio, meaning an electronic label radio associated with a higher RSSI may be assigned a larger weight. In the example of FIG. 5, w₃≥w₁≥w₂.

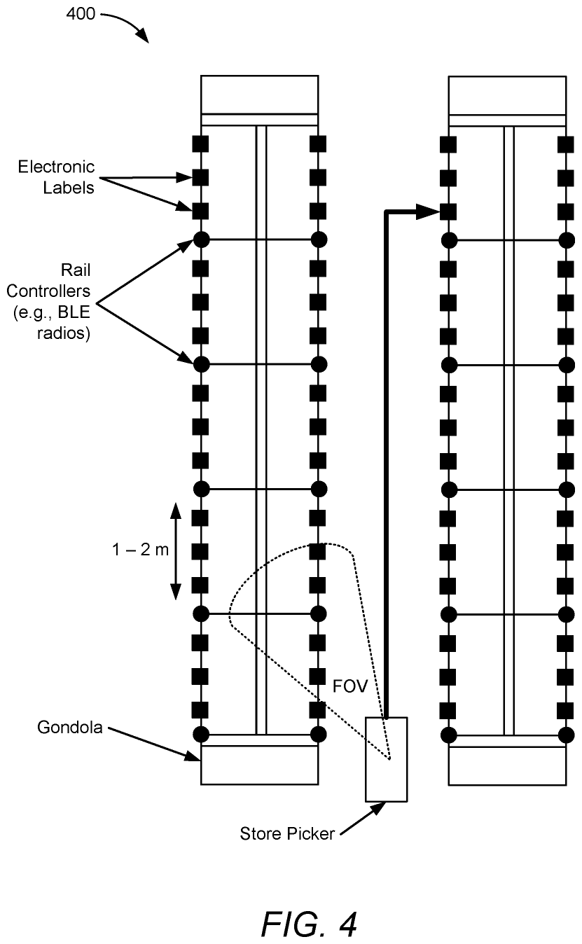

Low-cost battery-less energy harvesting “tags” (referred to as “eTags” or ambient Internet-of-Things (A-IoT) tags or simply electronic tags) are being developed that can be affixed to various types of assets for various purposes, such as positioning, tracking, verification/validation, product information storage, etc. FIG. 6 illustrates an example eTag 600, according to aspects of the disclosure. The example eTag 600 is a flexible printed circuit (FPC) having a size of, for example, 43 mm by 45 mm by 0.2 mm. In some cases, the eTag 600 may be encapsulated in a paper or plastic label with an adhesive backing that can be attached to an asset.

eTags do not include batteries, but rather, are energized by (harvest energy from) received wireless signals, similar to a radio frequency identification (RFID) tag. As such, the eTag 600 includes an energy harvesting antenna 610, which may operate in the 900 MHz range. An eTag, such as eTag 600, may be able to harvest energy from a transmitter as far away as 20 m (in contrast, an RFID tag needs to be within a few meters of the transmitter to be able to perform energy harvesting).

The energy captured by the energy harvesting antenna 610 is stored in an external capacitor 620, which in turn powers a test chip 630 and a transmit antenna 640. When powered by the external capacitor 620, the test chip 630 provides information for transmission to the transmit antenna 640. The transmit antenna 640 may operate in the 2.4 GHz range according to one or more communication protocols (e.g., BLE, Wi-Fi®, NR). For example, the test chip 630 and transmit antenna 640 may act as a BLE beacon and support BLE advertisement transmission. Note that in some cases, the transmit antenna 640 may also act as an energy harvesting antenna. In some cases, where the energy harvesting antenna 610 and the transmit antenna 640 are the same antenna, the combination of the energy harvesting antenna 610 and the transmit antenna 640 may be referred to as a transceiver.

In some cases, the eTag 600 may include one or more sensors 650. Such sensors may include temperature sensors, pressure sensors, and/or other low energy sensors.

In some cases, to position an eTag 600 using the positioning method illustrated by FIG. 5, the eTag 600 may be energized to transmit one or more BLE beacon transmissions to nearby electronic label radios (e.g., EL1, EL2, and EL3 in FIG. 5). The electronic label radios may report their RSSI measurements to the central management entity 110, which may calculate the position of the eTag 600 or forward the measurements to another entity for processing.

An example wireless communication protocol that may be utilized to support electronic label-to-AP signaling is the BLE generic attribute profile (GATT) protocol. For example, electronic labels may contain a BLE GATT server, and scan result read characteristics can be defined for target device RSSI measurements (e.g., for the reporting of target RSSI measurements from electronic label(s) to the electronic label AP). Advantages of the BLE GATT protocol include support for bulk data read operations, allowing for accumulation and less frequent reads of target device scan results. This can be useful if there are many active target devices (e.g., battery-less energy harvesting tags (eTags)). A downside of the BLE GATT protocol is the overhead of the BLUETOOTH® asynchronous connection-oriented logical transport (ACL) connect/disconnect for every query, which results in slower response time.

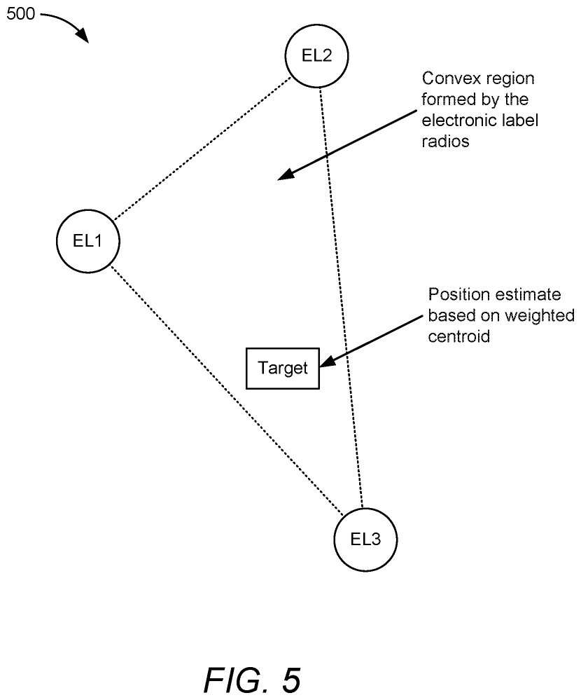

FIG. 7 illustrates an example BLE GATT procedure 700, according to aspects of the disclosure. At stage (1), a GATT client performs service discovery with a GATT server. At stage (2), the GATT client populates a table of available service(s) of the GATT server obtained from stage (1). At stage (3a), the GATT client transmits a client request to the GATT server. At stage (4a), the GATT server transmits a server response to the client request from stage (3a). As an alternative to (or in addition to) stages (3a) and (4a), at stage (3b), the GATT client may transmit a switch ON indication or notification to the GATT server, and at stage (4b), the GATT server may perform a server-initiated data transfer.

Another example wireless communications protocol that may be utilized to support electronic label-to-AP signaling is the electronic label periodic advertising with responses (PAWR) protocol. In electronic label PAWR, electronic labels can be sent a vendor-specific command via an advertising synchronization packet from the AP, and target device RSSI data can be reported by the electronic label in a specific advertisement slot period. Electronic labels may be grouped and addressed as a group (via a group identifier (ID)). An advantage to this approach is minimum overhead and quick response time. A downside to this approach is the advertisement packet payload size is limited (48 bytes), so only one target device payload (40 bytes) may fit in one slot. As such, multiple target devices' data may need multiple slots. Note that the duration of a frame may vary from as low as 1.6 seconds to as long as 16 seconds (based on configuration).

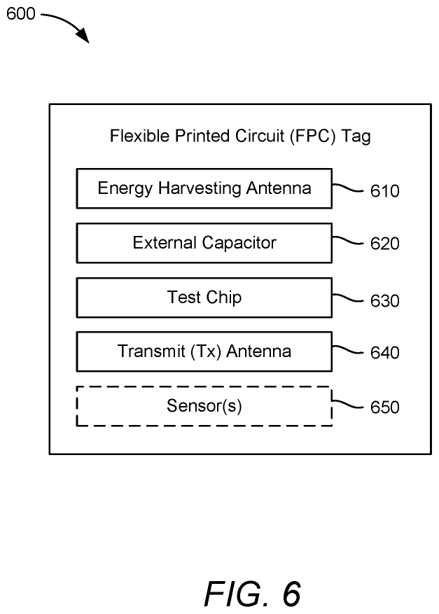

FIG. 8 illustrates an example electronic label PAWR scheme 800, according to aspects of the disclosure. The electronic label PAWR scheme 800 is described with respect to a cluster/group of electronic labels that includes four electronic labels, denoted as ELs 1-4. At slot to, the electronic label AP transmits scheduling information to electronic labels 1-4. Assuming that electronic labels 1-4 operate in electronic label radio scan mode (i.e., receive (Rx) mode) during slots t1-t4 (e.g., collecting electronic label measurement information), then electronic labels 1-4 each transmit measurement feedback collected during the electronic label radio scan mode to the electronic label AP during slots t5-t8. Note that each electronic label 1-4 may only wake up once every frame to listen and respond. As will be appreciated, for highly populated clusters/groups of electronic labels, the measurement feedback to the electronic label AP can take a significant amount of time and incur high signaling and scheduling overhead.

As described above, electronic labels, such as electronic labels, are being deployed to display and update product information digitally. However, these displays may be accidentally, or deliberately, moved from their original location (such as by children or malicious individuals), resulting in the electronic label display being placed at the wrong/unintended location. In positioning scenarios, such a change in radio location can result in inaccurate/wrong ground truth locations, which in turn degrades the positioning accuracy of a target device (e.g., an eTag or UE).

At a high level, the present disclosure provides techniques for (1) using RF measurements (between electronic label radios and electronic label APs/other devices) to track of electronic label radio locations and (2) using camera measurements to track electronic label display locations (and electronic label radio locations, in the case of standalone electronic labels). Note that while the techniques described herein refer to electronic labels specifically, they are equally applicable to any type of electronic label/display device.

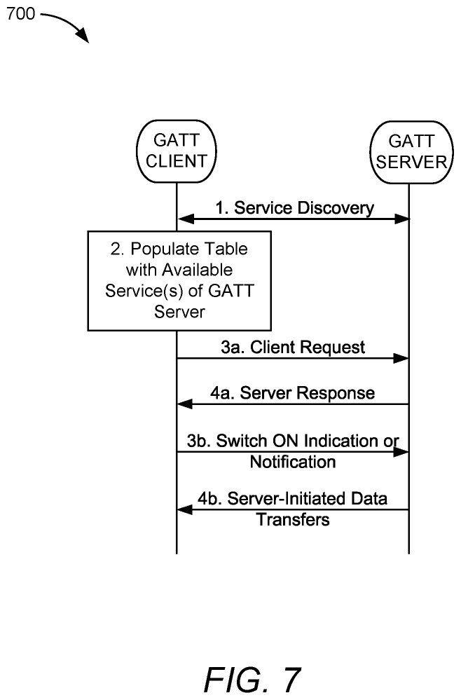

FIG. 9 is a diagram 900 illustrating an example scenario of using RF measurements to track electronic label radio locations, according to aspects of the disclosure. The scenario illustrated in FIG. 9 involves a set of electronic label radios and a set of electronic label displays located on, for example, a shelving unit of a retail store or warehouse, an electronic label AP (e.g., wireless communication access point 120), and a server (e.g., central management entity 110). The electronic label radios illustrated in FIG. 9 may be wireless radios associated with the rails to which the electronic labels are attached (e.g., rail controllers 130) or standalone electronic labels. The electronic label displays may be electronic labels without integrated radios. The dashed arrows from the ELS radios to the UE(s) and other device(s) represent electronic label radio beacons.

In some cases, RF measurements as part of a PAWR procedure may be used to keep track of electronic label radio locations. The method begins with an initialization phase, in which, at the time of deployment, a database of electronic label radio locations is maintained. This database may have been obtained/populated through a careful survey of the environment of the electronic label radios. Additionally, during the initialization phase, care may be taken to ensure that the electronic label radio locations are not changed for at least a short period of time (e.g., 60×1.6=96 seconds or slightly longer, assuming about 60 frames).

As part of the PAWR procedure, an electronic label AP exchanges advertisements with all electronic label radios. The electronic label AP may trigger the transmission of an electronic label response packet from every electronic label radio, even if they have no data to send. In this case, the electronic label radios may send empty payloads (just headers) to conserve power.

There may be a minimum threshold number (e.g., N=50) of electronic label response packets (per electronic label radio) that need to be received at the electronic label AP. The electronic label AP measures the RSSI of each response packet, and additionally any other positioning measurement(s) (e.g., time of arrival (ToA), angle of arrival (AoA), etc.). The electronic label AP may then relay the positioning measurements to the server (e.g., an edge server).

In the event that N electronic label response packets have not been received from each electronic label radio (even after N frames), the electronic label AP may trigger the transmission of additional electronic label response packets from those electronic label radios with less than N successful receptions.

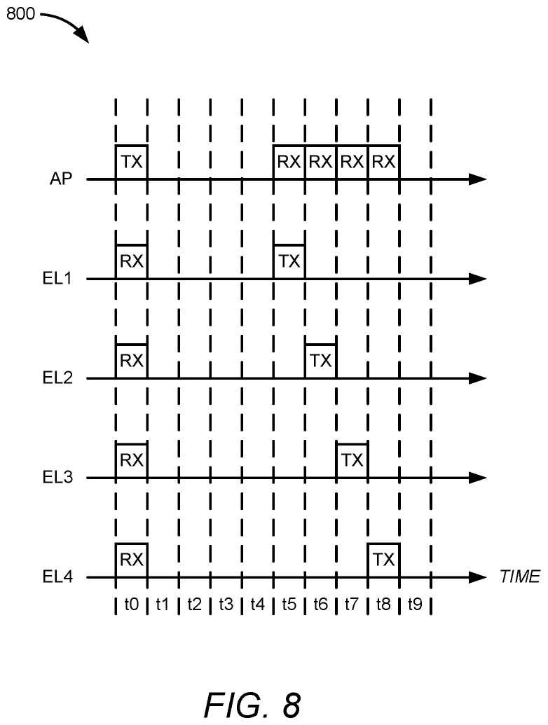

The same measurement acquisition may also apply to one or more other wireless devices in the vicinity of the electronic label radios. FIG. 10 is a diagram 1000 illustrating an example scenario of using RF measurements to track electronic label radio locations, according to aspects of the disclosure. The scenario illustrated in FIG. 10 involves a set of electronic label radios and a set of electronic label displays located on, for example, a shelving unit of a retail store or warehouse, a server (e.g., central management entity 110), a UE, and another device. The electronic label AP is not shown.

The electronic label radios illustrated in FIG. 10 may be wireless radios associated with the rails to which the electronic labels are attached (e.g., rail controllers 130) or standalone electronic labels. The electronic label displays may be electronic labels without integrated radios. The dashed arrows from the ELS radios to the UE(s) and other device(s) represent electronic label radio beacons.

As shown in FIG. 10, opportunistic measurements may be acquired from other devices in the retail store/warehouse. For example, there may be smart appliances (e.g., televisions, refrigerators, other electronic items) and network infrastructure with BLE receivers, such as security cameras and other APs (which may support, for example, BLE along with Wi-Fi®). These devices are generally fixed with known locations.

The other devices may also include one or more UEs held by store workers or staff members, where the UEs are kept static at ground truth points for a period of time (e.g., N number of frames). A UE may also belong to a consumer associated with the store network (e.g., using an application on the UE).

Regardless of the type of device, each of the other devices may report to the server, for each electronic label radio measured, an RSSI value associated with the electronic label radio, an electronic label MAC ID, the MAC ID of the reporting device, and the location of the reporting device (if known to the device).

In some cases, the server may provide a list of BLE time slots and channels to scan to the above devices, such that the electronic label radio beacons are received successfully.

With continued reference to the initialization phase, once the threshold number of response packets have been received from all electronic label radios (and optionally for all other wireless devices as well), the initialization phase is ended. The end result is a lookup table (LUT) that is stored at the server and includes RF measurements (e.g., RSSI measurements) between electronic label radios and the electronic label AP, along with any other opportunistic devices that can perform measurements.

After the initialization phase is an audit, or validation, phase. Throughout the lifecycle of the electronic labels, their radio locations may be tracked with reference to the LUT that is acquired during the initialization phase. This validation may be carried out according to one or more of the following methods: (1) periodic validation and/or (2) opportunistic or trigger-based validation.

Referring to periodic validation, in this case, an electronic label AP may periodically perform RF measurements corresponding to one or more electronic label radios (when they transmit electronic label response packets) and relay them to the server. The server maintains a filtered statistic of the RF measurements (e.g., the average over 10 values, the median over 20 values, or the like), referred to as a “validation value.” The server may detect a first anomaly when (1) the difference between the validation value and the corresponding LUT value exceeds a threshold (e.g., the average RSSI corresponding to an electronic label (across 10 values) is 10 dB lower than the LUT value), (2) there is a significant variation or high variance (e.g., above some threshold) in the incoming RF measurements corresponding to an electronic label radio, and/or (3) a position estimate of an electronic label radio (using RF measurements from multiple devices) is beyond a threshold distance from the ground truth value (e.g., determined at deployment or during the initialization phase).

However, these variations may occur in the short-term due to obstacles or changes in the environment. As such, the server may rely on a prolonged duration of data collection (such as over a few hours) before declaring an error/raising an alert for a given electronic label radio. Accordingly, in response to a first anomaly detection, the server may request the electronic label AP to increase its frequency of measuring values and reporting them (to generate more measurements) over a longer period of time. The server may then raise an error/alert for a given electronic label radio if its RF measurements (i.e., the filtered values over time) are still above a threshold value with respect to the corresponding LUT values.

In some cases, in addition to the electronic label AP, other wireless devices may perform the same procedure as the electronic label AP.

In some cases, the electronic label AP may only measure and report RF measurements for those electronic label radios that are likely an anomaly. In this case, the electronic label AP may use a local copy of the LUT for this purpose, or the server may provide a list of such anomalous electronic label radios to the electronic label AP. The electronic label AP may also indicate to the anomalous electronic label radio(s) to increase its frequency of sending response packets.

In some cases, further validation checks may be performed by the server when two or more co-located electronic label radios are associated with an anomaly. This may occur when an entire shelving gondola has been shifted/moved around. In this case, the server may trigger an alert for multiple such electronic label radios and also raise an alert for the gondola itself (as potentially other electronic label radios may have been affected)

Referring now to opportunistic or trigger-based validation, here, to reduce the overhead between the electronic label AP and the server, the server may instead rely on opportunistic detections/measurements from other wireless devices before requesting the electronic label AP to relay RF measurements. In this case, one or more UEs held by shoppers/consumers (and/or other devices held by store/warehouse workers and/or infrastructure devices such as APs) may receive and measure electronic label radio beacons, which are then relayed to the server. The UEs may also report their known location estimates.

If an anomaly is detected, the server indicates to the electronic label AP to begin reporting RF measurements pertaining to the electronic label radio(s) under consideration (suspected of dislocation). The electronic label AP reports the desired information to the server, and may also indicate to the anomalous/suspected electronic label radio(s) to increase its frequency of response. This approach ensures that the electronic label AP only reports RF measurements when required, enabling other information, such as data/payloads, to be prioritized for delivery to the server.

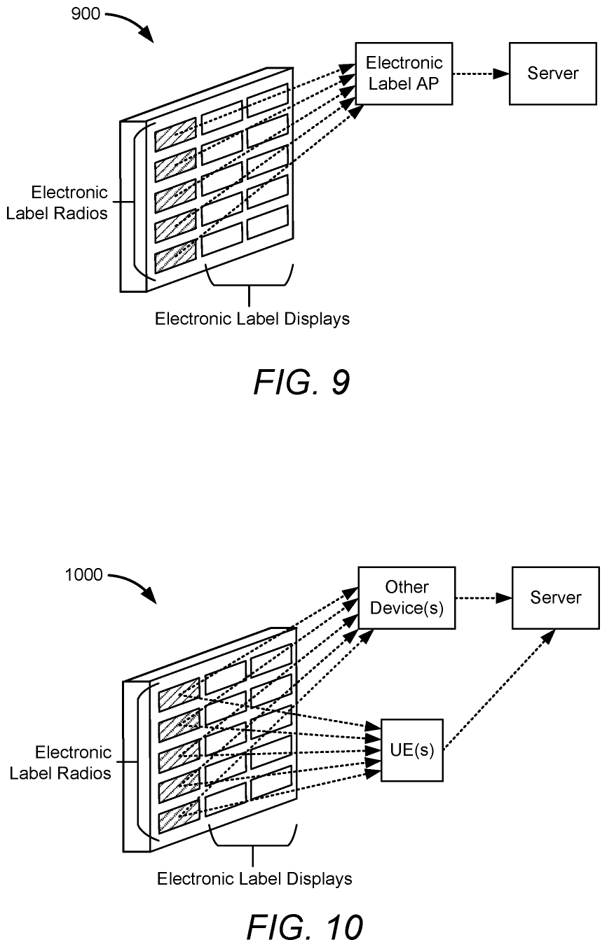

FIG. 11 illustrates an example method 1100 of positioning, according to aspects of the disclosure. In an aspect, method 1100 may be performed by a server (e.g., any of the server devices described herein).

At operation 1110, the server may receive a plurality of RF measurements of a plurality of beacon signals transmitted by an electronic label radio.

In an aspect, where the server is a UE, operation 1110 may be performed by the one or more WWAN transceivers 310, the one or more short-range wireless transceivers 320, the one or more processors 332, memory 340, and/or positioning component 342, any or all of which may be considered means for performing this operation.

In an aspect, where the server is a base station or base station component, operation 1110 may be performed by the one or more WWAN transceivers 350, the one or more short-range wireless transceivers 360, the one or more network transceivers 380, the one or more processors 384, memory 386, and/or positioning component 388, any or all of which may be considered means for performing this operation.

In an aspect, where the server is a network entity, operation 1110 may be performed by the one or more network transceivers 390, the one or more processors 394, memory 396, and/or positioning component 398, any or all of which may be considered means for performing this operation.

At operation 1120, the server may determine whether a statistic of a set of RF measurements of the plurality of RF measurements received over a measurement window (e.g., some length of time or number of measurements) varies from an expected value of the statistic by more than a threshold.

In an aspect, where the server is a UE, operation 1120 may be performed by the one or more WWAN transceivers 310, the one or more short-range wireless transceivers 320, the one or more processors 332, memory 340, and/or positioning component 342, any or all of which may be considered means for performing this operation.

In an aspect, where the server is a base station or base station component, operation 1120 may be performed by the one or more WWAN transceivers 350, the one or more short-range wireless transceivers 360, the one or more network transceivers 380, the one or more processors 384, memory 386, and/or positioning component 388, any or all of which may be considered means for performing this operation.

In an aspect, where the server is a network entity, operation 1120 may be performed by the one or more network transceivers 390, the one or more processors 394, memory 396, and/or positioning component 398, any or all of which may be considered means for performing this operation.

At operation 1130, the server may perform one or more validation operations based on a determination that the statistic of the set of RF measurements received over the measurement window varies from the expected value of the statistic by more than the threshold.

In an aspect, where the server is a UE, operation 1130 may be performed by the one or more WWAN transceivers 310, the one or more short-range wireless transceivers 320, the one or more processors 332, memory 340, and/or positioning component 342, any or all of which may be considered means for performing this operation.

In an aspect, where the server is a base station or base station component, operation 1130 may be performed by the one or more WWAN transceivers 350, the one or more short-range wireless transceivers 360, the one or more network transceivers 380, the one or more processors 384, memory 386, and/or positioning component 388, any or all of which may be considered means for performing this operation.

In an aspect, where the server is a network entity, operation 1130 may be performed by the one or more network transceivers 390, the one or more processors 394, memory 396, and/or positioning component 398, any or all of which may be considered means for performing this operation.

As will be appreciated, a technical advantage of the method 1100 is enabling the server to track electronic label radio locations.

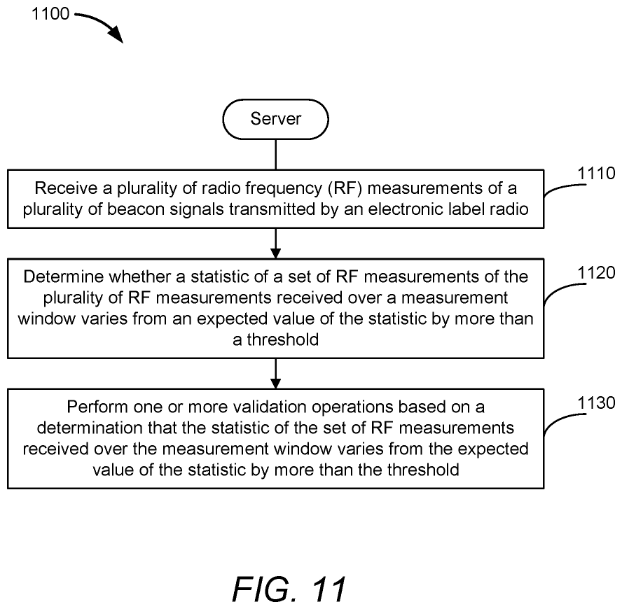

FIG. 12 is a diagram 1200 illustrating an example scenario of using camera infrastructure to track electronic label radios and a set of electronic label displays display locations, according to aspects of the disclosure. The scenario illustrated in FIG. 12 involves a set of electronic label displays located on, for example, a shelving unit of a retail store or warehouse, a camera (e.g., a security camera), and a server (e.g., central management entity 110). The electronic label AP is not shown. The electronic label displays illustrated in FIG. 12 may be electronic labels with or without integrated radios.

The method begins with an initialization phase. At the time of deployment, a sequential visual indication may be displayed by each electronic label (illustrated by cross-hatching in FIG. 12). The indication may be (1) a light-emitting diode (LED) display (e.g., a specific color and/or pattern) and/or (2) an electronic label display (e.g., certain colors/patterns/shapes/etc.). The foregoing indications may be displayed in tandem (simultaneously) with the electronic label response packets that are sent by each of the electronic label radios.

By keeping track of the timestamps, the server may correlate an electronic label ID (received from the electronic label AP) with the corresponding visual estimate from the camera infrastructure (e.g., a security camera (sub)system). The camera system may send a visual estimate report to the server.

As part of the LUT stored at the server, a tuple comprising a visual estimate and electronic label ID may be maintained. A visual estimate may be in the form of (1) a bounding box with associated coordinates (e.g., coordinates of a corner of the bounding box along with the dimensions of the box), (2) only location coordinates (e.g., the centroid of the box), and/or (3) a raw image associated with the electronic label (optionally with a detection of a visual indication displayed by the electronic label).

These stages of the initialization phase may be repeated as needed, until clear visual estimates are registered and updated in the LUT.

The next phase is an audit, or validation, phase. In order to distinguish between electronic label displays, the camera system would need each electronic label display to display a unique visual marker/indication (as the electronic labels may look very similar to one another from the perspective of the camera).

Similar to the initialization phase, each electronic label may display a sequential visual indication with a very low duty cycle. This action may be triggered by the server (via the electronic label AP).

In some cases, the electronic label AP may specify the visual indication to be displayed (e.g., a bitmap from the electronic label AP may be mapped to a certain color/pattern/shape/etc.). The electronic label AP may either indicate that the electronic label is to display the indication on-demand (i.e., in response to the request from the electronic label AP), or may provide a duty cycle with which the electronic label is to display the indication.

In some cases, the visual indication may be opportunistic in nature. That is, the electronic label may display certain indications as part of regular operation (i.e., not specifically for the auditing phase). For example, the electronic label may occasionally display indications (e.g., a flashing LED) to alert shoppers or store employees of some information. In that case, the camera system may be instructed to capture an image of the electronic label opportunistically to acquire audit/validation data without additional electronic label battery usage.

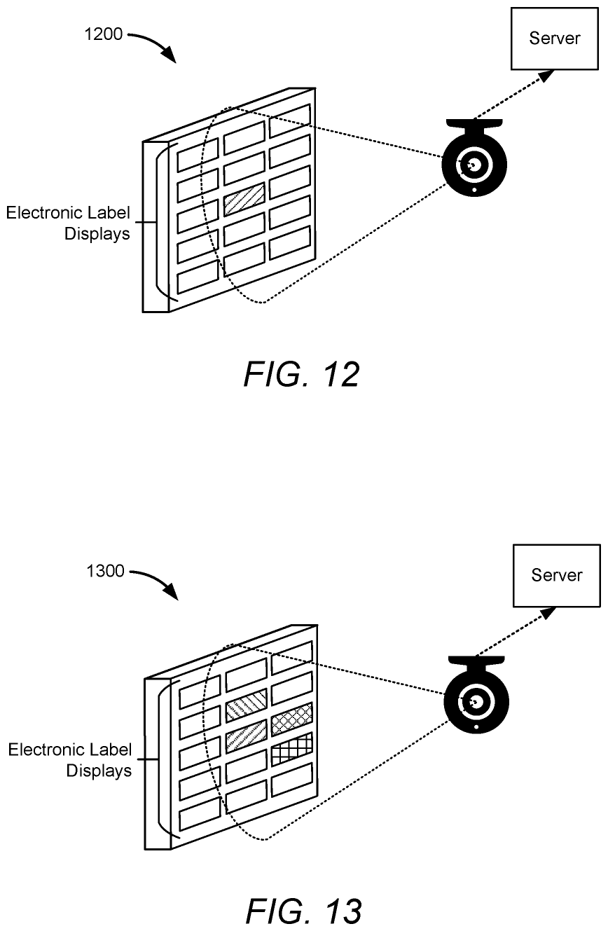

In some cases, the server may also trigger the simultaneous display of visual indications from multiple electronic labels (via the electronic label AP). FIG. 13 is a diagram 1300 illustrating an example scenario of multiple electronic labels simultaneously displaying a visual indication, according to aspects of the disclosure. The scenario illustrated in FIG. 13 involves a set of electronic label displays located on, for example, a shelving unit of a retail store or warehouse, a camera (e.g., a security camera), and a server (e.g., central management entity 110). The electronic label AP is not shown. The electronic label displays illustrated in FIG. 13 may be electronic labels with or without integrated radios.

In this case, electronic labels that are closely located to one another (e.g., within some threshold distance, such as within the image view of the camera) may be assigned distinct visual markers (as shown by the different cross-hatching in FIG. 13). For example, each electronic label may display a different color/pattern/shape/etc. indication. This approach can reduce overhead and allow for faster validation of electronic label display locations.

In some cases, the server may compare the locations of the detected bounding boxes around a given electronic label on a per-electronic label basis and trigger an error/alert when a threshold distance is observed between the detected bounding box and the LUT reference.

In some cases, where multiple cameras that have visibility of the same electronic label, the LUT entry for that electronic label may comprise multiple such visual estimates of the electronic label.

In some cases, an anomaly detection in the case of RF measurements (as described above with reference to FIGS. 9 and 10) could in turn trigger a camera-based validation for robustness (and vice-versa), since a change in electronic label radio location would likely imply a change in electronic label display location as well. This may involve the server (via the electronic label AP) indicating to the electronic label to display an indication, and the server also indicating to the camera to detect the indication displayed by the electronic label.

In some cases, machine learning based methods (such as classification) may be applied using the LUT entries. In this case, during the initialization phase, the server may acquire and store sufficient data to train a reliable model. This is applicable to both the RF measurements technique (as described above with reference to FIGS. 9 and 10) and the camera infrastructure technique (as described above with reference to FIGS. 12 and 13).

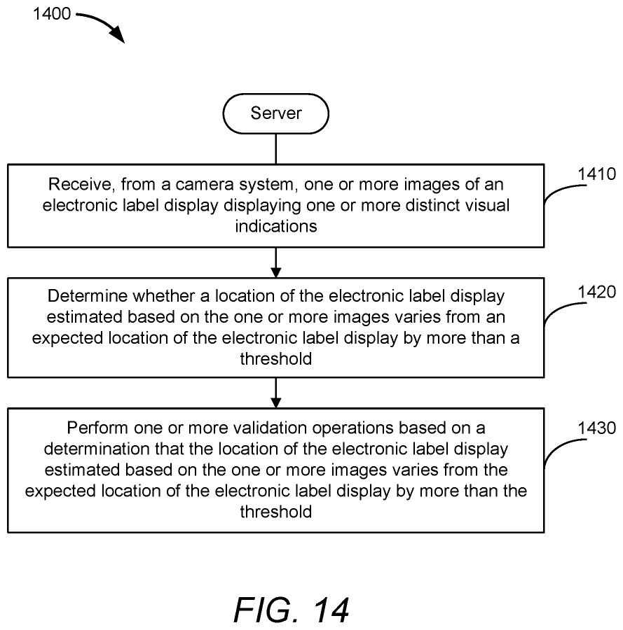

FIG. 14 illustrates an example method 1400 of positioning, according to aspects of the disclosure. In an aspect, method 1400 may be performed by a server (e.g., any of the server devices described herein).

At operation 1410, the server may receive, from a camera system, one or more images of an electronic label display displaying one or more distinct visual indications.

In an aspect, where the server is a UE, operation 1410 may be performed by the one or more WWAN transceivers 310, the one or more short-range wireless transceivers 320, the one or more processors 332, memory 340, and/or positioning component 342, any or all of which may be considered means for performing this operation.

In an aspect, where the server is a base station or base station component, operation 1410 may be performed by the one or more WWAN transceivers 350, the one or more short-range wireless transceivers 360, the one or more network transceivers 380, the one or more processors 384, memory 386, and/or positioning component 388, any or all of which may be considered means for performing this operation.

In an aspect, where the server is a network entity, operation 1410 may be performed by the one or more network transceivers 390, the one or more processors 394, memory 396, and/or positioning component 398, any or all of which may be considered means for performing this operation.

At operation 1420, the server may determine whether a location of the electronic label display estimated based on the one or more images varies from an expected location of the electronic label display by more than a threshold.

In an aspect, where the server is a UE, operation 1420 may be performed by the one or more WWAN transceivers 310, the one or more short-range wireless transceivers 320, the one or more processors 332, memory 340, and/or positioning component 342, any or all of which may be considered means for performing this operation.

In an aspect, where the server is a base station or base station component, operation 1420 may be performed by the one or more WWAN transceivers 350, the one or more short-range wireless transceivers 360, the one or more network transceivers 380, the one or more processors 384, memory 386, and/or positioning component 388, any or all of which may be considered means for performing this operation.

In an aspect, where the server is a network entity, operation 1420 may be performed by the one or more network transceivers 390, the one or more processors 394, memory 396, and/or positioning component 398, any or all of which may be considered means for performing this operation.

At operation 1430, the server may perform one or more validation operations based on a determination that the location of the electronic label display estimated based on the one or more images varies from the expected location of the electronic label display by more than the threshold.

In an aspect, where the server is a UE, operation 1430 may be performed by the one or more WWAN transceivers 310, the one or more short-range wireless transceivers 320, the one or more processors 332, memory 340, and/or positioning component 342, any or all of which may be considered means for performing this operation.

In an aspect, where the server is a base station or base station component, operation 1430 may be performed by the one or more WWAN transceivers 350, the one or more short-range wireless transceivers 360, the one or more network transceivers 380, the one or more processors 384, memory 386, and/or positioning component 388, any or all of which may be considered means for performing this operation.

In an aspect, where the server is a network entity, operation 1430 may be performed by the one or more network transceivers 390, the one or more processors 394, memory 396, and/or positioning component 398, any or all of which may be considered means for performing this operation.

As will be appreciated, a technical advantage of the method 1400 is enabling the server to track electronic label display locations.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1: A method of positioning performed by a server, comprising: receiving a plurality of radio frequency (RF) measurements of a plurality of beacon signals transmitted by an electronic label radio; determining whether a statistic of a set of RF measurements of the plurality of RF measurements received over a measurement window varies from an expected value of the statistic by more than a threshold; and performing one or more validation operations based on a determination that the statistic of the set of RF measurements received over the measurement window varies from the expected value of the statistic by more than the threshold.

Clause 2: The method of clause 1, wherein the one or more validation operations include: an increase in a length of the measurement window; transmission of a request to increase a frequency of obtaining and reporting RF measurements associated with the electronic label radio; transmission of an alert; or any combination thereof.

Clause 3: The method of any of clauses 1 to 2, wherein the statistic is: an average of the set of RF measurements; a median of the set of RF measurements; or a location estimate of the electronic label radio determined based on the set of RF measurements.

Clause 4: The method of any of clauses 1 to 3, wherein the plurality of RF measurements is obtained based on beacon signals periodically transmitted by the electronic label radio.

Clause 5: The method of any of clauses 1 to 4, wherein the plurality of RF measurements is obtained by: an electronic label access point associated with the electronic label radio; an infrastructure device; or a user equipment (UE).

Clause 6: The method of any of clauses 1 to 5, further comprising: transmitting a request for the plurality of RF measurements based on a likelihood that the electronic label radio has moved being above a threshold or a determination that the electronic label radio has moved.

Clause 7: The method of any of clauses 1 to 6, further comprising: receiving RF measurements associated with a plurality of electronic label radios, including the electronic label radio; receiving identifiers of the plurality of electronic label radios; and generating a lookup table for the plurality of electronic label radios based on the identifiers of the plurality of electronic label radios and the RF measurements.

Clause 8: The method of any of clauses 1 to 7, wherein the identifiers of the plurality of electronic label radios and the RF measurements are received from: one or more electronic label access points; one or more infrastructure devices; one or more user equipments (UEs); or any combination thereof.

Clause 9: The method of any of clauses 1 to 8, wherein the lookup table further includes: identifiers of the one or more electronic label access points; identifiers of the one or more infrastructure devices; identifiers of the one or more UEs; or any combination thereof.

Clause 10: The method of any of clauses 1 to 9, wherein the RF measurements include: a received signal strength indicator (RSSI) measurement associated with each of the plurality of electronic label radios; a time of arrival (TOA) measurement associated with each of the plurality of electronic label radios; an angle of arrival (AOA) measurement associated with each of the plurality of electronic label radios; or any combination thereof.

Clause 11: The method of any of clauses 1 to 10, wherein each RF measurement of the RF measurements is determined based on a plurality of response packets received from a corresponding electronic label radio of the plurality of electronic label radios.

Clause 12: The method of any of clauses 1 to 11, wherein the expected value of the statistic is determined based on an entry in the lookup table for the electronic label radio.

Clause 13: A method of positioning performed by a server, comprising: receiving, from a camera system, one or more images of an electronic label display displaying one or more distinct visual indications; determining whether a location of the electronic label display estimated based on the one or more images varies from an expected location of the electronic label display by more than a threshold; and performing one or more validation operations based on a determination that the location of the electronic label display estimated based on the one or more images varies from the expected location of the electronic label display by more than the threshold.

Clause 14: The method of clause 13, wherein the one or more distinct visual indications are displayed on the electronic label display based on: a periodic duty cycle configured by the server; a trigger from the server; a periodic duty cycle configured by an electronic label access point associated with the electronic label display; a trigger from the electronic label access point associated with the electronic label display; regular operation of the electronic label display; or any combination thereof.

Clause 15: The method of any of clauses 13 to 14, wherein determining whether the location of the electronic label display estimated based on the one or more images varies from the expected location of the electronic label display by more than the threshold comprises: determining a bounding box around the electronic label display in the one or more images; and determining whether the bounding box varies from the expected location of the electronic label display by more than the threshold.

Clause 16: The method of any of clauses 13 to 15, further comprising: receiving a plurality of images of a plurality of electronic label displays, including the electronic label display; receiving a plurality of radio frequency (RF) measurements associated with the plurality of electronic label displays; receiving identifiers of the plurality of electronic label displays; and generating a lookup table for the plurality of electronic label displays based on the identifiers of the plurality of electronic label displays, the plurality of images, and the plurality of RF measurements.

Clause 17: The method of any of clauses 13 to 16, wherein an image of each electronic label display of the plurality of electronic label displays is captured at the same time as an RF measurement associated with the each electronic label display is obtained.

Clause 18: The method of any of clauses 13 to 17, wherein the lookup table includes: a bounding box indicating a location of each of the plurality of electronic label displays; location coordinates indicating the location of each of the plurality of electronic label displays; an image of each of the plurality of electronic label displays displaying a distinct visual indication; or any combination thereof.

Clause 19: The method of any of clauses 13 to 18, wherein the expected location of the electronic label display is determined based on an entry in the lookup table for the electronic label display.

Clause 20: A server, comprising: one or more memories; one or more transceivers; and one or more processors communicatively coupled to the one or more memories and the one or more transceivers, the one or more processors, either alone or in combination, configured to: receive, via the one or more transceivers, a plurality of radio frequency (RF) measurements of a plurality of beacon signals transmitted by an electronic label radio; determine whether a statistic of a set of RF measurements of the plurality of RF measurements received over a measurement window varies from an expected value of the statistic by more than a threshold; and perform one or more validation operations based on a determination that the statistic of the set of RF measurements received over the measurement window varies from the expected value of the statistic by more than the threshold.

Clause 21: The server of clause 20, wherein the one or more validation operations include: an increase in a length of the measurement window; transmission of a request to increase a frequency of obtaining and reporting RF measurements associated with the electronic label radio; transmission of an alert; or any combination thereof.

Clause 22: The server of any of clauses 20 to 21, wherein the statistic is: an average of the set of RF measurements; a median of the set of RF measurements; or a location estimate of the electronic label radio determined based on the set of RF measurements.

Clause 23: The server of any of clauses 20 to 22, wherein the plurality of RF measurements is obtained based on beacon signals periodically transmitted by the electronic label radio.

Clause 24: The server of any of clauses 20 to 23, wherein the plurality of RF measurements is obtained by: an electronic label access point associated with the electronic label radio; an infrastructure device; or a user equipment (UE).

Clause 25: The server of any of clauses 20 to 24, wherein the one or more processors, either alone or in combination, are further configured to: transmit, via the one or more transceivers, a request for the plurality of RF measurements based on a likelihood that the electronic label radio has moved being above a threshold or a determination that the electronic label radio has moved.

Clause 26: The server of any of clauses 20 to 25, wherein the one or more processors, either alone or in combination, are further configured to: receive, via the one or more transceivers, RF measurements associated with a plurality of electronic label radios, including the electronic label radio; receive, via the one or more transceivers, identifiers of the plurality of electronic label radios; and generate a lookup table for the plurality of electronic label radios based on the identifiers of the plurality of electronic label radios and the RF measurements.

Clause 27: The server of any of clauses 20 to 26, wherein the identifiers of the plurality of electronic label radios and the RF measurements are received from: one or more electronic label access points; one or more infrastructure devices; one or more user equipments (UEs); or any combination thereof.

Clause 28: The server of any of clauses 20 to 27, wherein the lookup table further includes: identifiers of the one or more electronic label access points; identifiers of the one or more infrastructure devices; identifiers of the one or more UEs; or any combination thereof.

Clause 29: The server of any of clauses 20 to 28, wherein the RF measurements include: a received signal strength indicator (RSSI) measurement associated with each of the plurality of electronic label radios; a time of arrival (TOA) measurement associated with each of the plurality of electronic label radios; an angle of arrival (AOA) measurement associated with each of the plurality of electronic label radios; or any combination thereof.

Clause 30: The server of any of clauses 20 to 29, wherein each RF measurement of the RF measurements is determined based on a plurality of response packets received from a corresponding electronic label radio of the plurality of electronic label radios.

Clause 31: The server of any of clauses 20 to 30, wherein the expected value of the statistic is determined based on an entry in the lookup table for the electronic label radio.

Clause 32: A server, comprising: one or more memories; one or more transceivers; and one or more processors communicatively coupled to the one or more memories and the one or more transceivers, the one or more processors, either alone or in combination, configured to: receive, via the one or more transceivers, from a camera system, one or more images of an electronic label display displaying one or more distinct visual indications; determine whether a location of the electronic label display estimated based on the one or more images varies from an expected location of the electronic label display by more than a threshold; and perform one or more validation operations based on a determination that the location of the electronic label display estimated based on the one or more images varies from the expected location of the electronic label display by more than the threshold.

Clause 33: The server of clause 32, wherein the one or more distinct visual indications are displayed on the electronic label display based on: a periodic duty cycle configured by the server; a trigger from the server; a periodic duty cycle configured by an electronic label access point associated with the electronic label display; a trigger from the electronic label access point associated with the electronic label display; regular operation of the electronic label display; or any combination thereof.

Clause 34: The server of any of clauses 32 to 33, wherein the one or more processors configured to determine comprises the one or more processors, either alone or in combination, configured to: determine a bounding box around the electronic label display in the one or more images; and determine whether the bounding box varies from the expected location of the electronic label display by more than the threshold.

Clause 35: The server of any of clauses 32 to 34, wherein the one or more processors, either alone or in combination, are further configured to: receive, via the one or more transceivers, a plurality of images of a plurality of electronic label displays, including the electronic label display; receive, via the one or more transceivers, a plurality of radio frequency (RF) measurements associated with the plurality of electronic label displays; receive, via the one or more transceivers, identifiers of the plurality of electronic label displays; and generate a lookup table for the plurality of electronic label displays based on the identifiers of the plurality of electronic label displays, the plurality of images, and the plurality of RF measurements.

Clause 36: The server of any of clauses 32 to 35, wherein an image of each electronic label display of the plurality of electronic label displays is captured at the same time as an RF measurement associated with the each electronic label display is obtained.

Clause 37: The server of any of clauses 32 to 36, wherein the lookup table includes: a bounding box indicating a location of each of the plurality of electronic label displays; location coordinates indicating the location of each of the plurality of electronic label displays; an image of each of the plurality of electronic label displays displaying a distinct visual indication; or any combination thereof.

Clause 38: The server of any of clauses 32 to 37, wherein the expected location of the electronic label display is determined based on an entry in the lookup table for the electronic label display.

Clause 39: A server, comprising: means for receiving a plurality of radio frequency (RF) measurements of a plurality of beacon signals transmitted by an electronic label radio; means for determining whether a statistic of a set of RF measurements of the plurality of RF measurements received over a measurement window varies from an expected value of the statistic by more than a threshold; and means for performing one or more validation operations based on a determination that the statistic of the set of RF measurements received over the measurement window varies from the expected value of the statistic by more than the threshold.

Clause 40: The server of clause 39, wherein the one or more validation operations include: an increase in a length of the measurement window; transmission of a request to increase a frequency of obtaining and reporting RF measurements associated with the electronic label radio; transmission of an alert; or any combination thereof.

Clause 41: The server of any of clauses 39 to 40, wherein the statistic is: an average of the set of RF measurements; a median of the set of RF measurements; or a location estimate of the electronic label radio determined based on the set of RF measurements.

Clause 42: The server of any of clauses 39 to 41, wherein the plurality of RF measurements is obtained based on beacon signals periodically transmitted by the electronic label radio.

Clause 43: The server of any of clauses 39 to 42, wherein the plurality of RF measurements is obtained by: an electronic label access point associated with the electronic label radio; an infrastructure device; or a user equipment (UE).

Clause 44: The server of any of clauses 39 to 43, further comprising: means for transmitting a request for the plurality of RF measurements based on a likelihood that the electronic label radio has moved being above a threshold or a determination that the electronic label radio has moved.

Clause 45: The server of any of clauses 39 to 44, further comprising: means for receiving RF measurements associated with a plurality of electronic label radios, including the electronic label radio means for receiving identifiers of the plurality of electronic label radios; and means for generating a lookup table for the plurality of electronic label radios based on the identifiers of the plurality of electronic label radios and the RF measurements.

Clause 46: The server of any of clauses 39 to 45, wherein the identifiers of the plurality of electronic label radios and the RF measurements are received from: one or more electronic label access points; one or more infrastructure devices; one or more user equipments (UEs); or any combination thereof.

Clause 47: The server of any of clauses 39 to 46, wherein the lookup table further includes: identifiers of the one or more electronic label access points; identifiers of the one or more infrastructure devices; identifiers of the one or more UEs; or any combination thereof.

Clause 48: The server of any of clauses 39 to 47, wherein the RF measurements include: a received signal strength indicator (RSSI) measurement associated with each of the plurality of electronic label radios; a time of arrival (TOA) measurement associated with each of the plurality of electronic label radios; an angle of arrival (AOA) measurement associated with each of the plurality of electronic label radios; or any combination thereof.

Clause 49: The server of any of clauses 39 to 48, wherein each RF measurement of the RF measurements is determined based on a plurality of response packets received from a corresponding electronic label radio of the plurality of electronic label radios.

Clause 50: The server of any of clauses 39 to 49, wherein the expected value of the statistic is determined based on an entry in the lookup table for the electronic label radio.

Clause 51: A server, comprising: means for receiving, from a camera system, one or more images of an electronic label display displaying one or more distinct visual indications; means for determining whether a location of the electronic label display estimated based on the one or more images varies from an expected location of the electronic label display by more than a threshold; and means for performing one or more validation operations based on a determination that the location of the electronic label display estimated based on the one or more images varies from the expected location of the electronic label display by more than the threshold.

Clause 52: The server of clause 51, wherein the one or more distinct visual indications are displayed on the electronic label display based on: a periodic duty cycle configured by the server; a trigger from the server; a periodic duty cycle configured by an electronic label access point associated with the electronic label display; a trigger from the electronic label access point associated with the electronic label display; regular operation of the electronic label display; or any combination thereof.

Clause 53: The server of any of clauses 51 to 52, wherein the means for determining comprises: means for determining a bounding box around the electronic label display in the one or more images; and means for determining whether the bounding box varies from the expected location of the electronic label display by more than the threshold.

Clause 54: The server of any of clauses 51 to 53, further comprising: means for receiving a plurality of images of a plurality of electronic label displays, including the electronic label display means for receiving a plurality of radio frequency (RF) measurements associated with the plurality of electronic label displays means for receiving identifiers of the plurality of electronic label displays; and means for generating a lookup table for the plurality of electronic label displays based on the identifiers of the plurality of electronic label displays, the plurality of images, and the plurality of RF measurements.

Clause 55: The server of any of clauses 51 to 54, wherein an image of each electronic label display of the plurality of electronic label displays is captured at the same time as an RF measurement associated with the each electronic label display is obtained.

Clause 56: The server of any of clauses 51 to 55, wherein the lookup table includes: a bounding box indicating a location of each of the plurality of electronic label displays; location coordinates indicating the location of each of the plurality of electronic label displays; an image of each of the plurality of electronic label displays displaying a distinct visual indication; any combination thereof.

Clause 57: The server of any of clauses 51 to 56, wherein the expected location of the electronic label display is determined based on an entry in the lookup table for the electronic label display.

Clause 58: A non-transitory computer-readable medium storing computer-executable instructions that, when executed by a server, cause the server to: receive a plurality of radio frequency (RF) measurements of a plurality of beacon signals transmitted by an electronic label radio; determine whether a statistic of a set of RF measurements of the plurality of RF measurements received over a measurement window varies from an expected value of the statistic by more than a threshold; and perform one or more validation operations based on a determination that the statistic of the set of RF measurements received over the measurement window varies from the expected value of the statistic by more than the threshold.

Clause 59: The non-transitory computer-readable medium of clause 58, wherein the one or more validation operations include: an increase in a length of the measurement window; transmission of a request to increase a frequency of obtaining and reporting RF measurements associated with the electronic label radio; transmission of an alert; or any combination thereof.

Clause 60: The non-transitory computer-readable medium of any of clauses 58 to 59, wherein the statistic is: an average of the set of RF measurements; a median of the set of RF measurements; or a location estimate of the electronic label radio determined based on the set of RF measurements.

Clause 61: The non-transitory computer-readable medium of any of clauses 58 to 60, wherein the plurality of RF measurements is obtained based on beacon signals periodically transmitted by the electronic label radio.

Clause 62: The non-transitory computer-readable medium of any of clauses 58 to 61, wherein the plurality of RF measurements is obtained by: an electronic label access point associated with the electronic label radio; an infrastructure device; or a user equipment (UE).

Clause 63: The non-transitory computer-readable medium of any of clauses 58 to 62, further comprising computer-executable instructions that, when executed by the server, cause the server to: transmit a request for the plurality of RF measurements based on a likelihood that the electronic label radio has moved being above a threshold or a determination that the electronic label radio has moved.

Clause 64: The non-transitory computer-readable medium of any of clauses 58 to 63, further comprising computer-executable instructions that, when executed by the server, cause the server to: receive RF measurements associated with a plurality of electronic label radios, including the electronic label radio; receive identifiers of the plurality of electronic label radios; and generate a lookup table for the plurality of electronic label radios based on the identifiers of the plurality of electronic label radios and the RF measurements.

Clause 65: The non-transitory computer-readable medium of any of clauses 58 to 64, wherein the identifiers of the plurality of electronic label radios and the RF measurements are received from: one or more electronic label access points; one or more infrastructure devices; one or more user equipments (UEs); or any combination thereof.

Clause 66: The non-transitory computer-readable medium of any of clauses 58 to 65, wherein the lookup table further includes: identifiers of the one or more electronic label access points; identifiers of the one or more infrastructure devices; identifiers of the one or more UEs; or any combination thereof.

Clause 67: The non-transitory computer-readable medium of any of clauses 58 to 66, wherein the RF measurements include: a received signal strength indicator (RSSI) measurement associated with each of the plurality of electronic label radios; a time of arrival (TOA) measurement associated with each of the plurality of electronic label radios; an angle of arrival (AOA) measurement associated with each of the plurality of electronic label radios; or any combination thereof.

Clause 68: The non-transitory computer-readable medium of any of clauses 58 to 67, wherein each RF measurement of the RF measurements is determined based on a plurality of response packets received from a corresponding electronic label radio of the plurality of electronic label radios.

Clause 69: The non-transitory computer-readable medium of any of clauses 58 to 68, wherein the expected value of the statistic is determined based on an entry in the lookup table for the electronic label radio.

Clause 70: A non-transitory computer-readable medium storing computer-executable instructions that, when executed by a server, cause the server to: receive, from a camera system, one or more images of an electronic label display displaying one or more distinct visual indications; determine whether a location of the electronic label display estimated based on the one or more images varies from an expected location of the electronic label display by more than a threshold; and perform one or more validation operations based on a determination that the location of the electronic label display estimated based on the one or more images varies from the expected location of the electronic label display by more than the threshold.

Clause 71: The non-transitory computer-readable medium of clause 70, wherein the one or more distinct visual indications are displayed on the electronic label display based on: a periodic duty cycle configured by the server; a trigger from the server; a periodic duty cycle configured by an electronic label access point associated with the electronic label display; a trigger from the electronic label access point associated with the electronic label display; regular operation of the electronic label display; or any combination thereof.

Clause 72: The non-transitory computer-readable medium of any of clauses 70 to 71, wherein the computer-executable instructions that, when executed by the server, cause the server to determine comprise computer-executable instructions that, when executed by the server, cause the server to: determine a bounding box around the electronic label display in the one or more images; and determine whether the bounding box varies from the expected location of the electronic label display by more than the threshold.

Clause 73: The non-transitory computer-readable medium of any of clauses 70 to 72, further comprising computer-executable instructions that, when executed by the server, cause the server to: receive a plurality of images of a plurality of electronic label displays, including the electronic label display; receive a plurality of radio frequency (RF) measurements associated with the plurality of electronic label displays; receive identifiers of the plurality of electronic label displays; and generate a lookup table for the plurality of electronic label displays based on the identifiers of the plurality of electronic label displays, the plurality of images, and the plurality of RF measurements.

Clause 74: The non-transitory computer-readable medium of any of clauses 70 to 73, wherein an image of each electronic label display of the plurality of electronic label displays is captured at the same time as an RF measurement associated with the each electronic label display is obtained.

Clause 75: The non-transitory computer-readable medium of any of clauses 70 to 74, wherein the lookup table includes: a bounding box indicating a location of each of the plurality of electronic label displays; location coordinates indicating the location of each of the plurality of electronic label displays; an image of each of the plurality of electronic label displays displaying a distinct visual indication; or any combination thereof.

Clause 76: The non-transitory computer-readable medium of any of clauses 70 to 75, wherein the expected location of the electronic label display is determined based on an entry in the lookup table for the electronic label display.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A server, comprising:
one or more memories;
one or more transceivers; and
one or more processors communicatively coupled to the one or more memories and the one or more transceivers, the one or more processors, either alone or in combination, configured to:
receive, via the one or more transceivers, a plurality of radio frequency (RF) measurements of a plurality of beacon signals transmitted by an electronic label radio;
determine whether a statistic of a set of RF measurements of the plurality of RF measurements received over a measurement window varies from an expected value of the statistic by more than a threshold; and
perform one or more validation operations based on a determination that the statistic of the set of RF measurements received over the measurement window varies from the expected value of the statistic by more than the threshold.

2. The server of claim 1, wherein the one or more validation operations include:
an increase in a length of the measurement window;
transmission of a request to increase a frequency of obtaining and reporting RF measurements associated with the electronic label radio;
transmission of an alert; or
any combination thereof.

3. The server of claim 1, wherein the statistic is:
an average of the set of RF measurements;
a median of the set of RF measurements; or
a location estimate of the electronic label radio determined based on the set of RF measurements.

4. The server of claim 1, wherein the plurality of RF measurements is obtained based on beacon signals periodically transmitted by the electronic label radio.

5. The server of claim 1, wherein the plurality of RF measurements is obtained by:
an electronic label access point associated with the electronic label radio;
an infrastructure device; or
a user equipment (UE).

6. The server of claim 1, wherein the one or more processors, either alone or in combination, are further configured to:
transmit, via the one or more transceivers, a request for the plurality of RF measurements based on a likelihood that the electronic label radio has moved being above a threshold or a determination that the electronic label radio has moved.

7. The server of claim 1, wherein the one or more processors, either alone or in combination, are further configured to:
receive, via the one or more transceivers, RF measurements associated with a plurality of electronic label radios, including the electronic label radio;
receive, via the one or more transceivers, identifiers of the plurality of electronic label radios; and
generate a lookup table for the plurality of electronic label radios based on the identifiers of the plurality of electronic label radios and the RF measurements.

8. The server of claim 7, wherein the identifiers of the plurality of electronic label radios and the RF measurements are received from:
one or more electronic label access points;
one or more infrastructure devices;
one or more user equipments (UEs); or
any combination thereof.

9. The server of claim 8, wherein the lookup table further includes:
identifiers of the one or more electronic label access points;
identifiers of the one or more infrastructure devices;
identifiers of the one or more UEs; or
any combination thereof.

10. The server of claim 7, wherein the RF measurements include:
a received signal strength indicator (RSSI) measurement associated with each of the plurality of electronic label radios;
a time of arrival (TOA) measurement associated with each of the plurality of electronic label radios;
an angle of arrival (AOA) measurement associated with each of the plurality of electronic label radios; or
any combination thereof.

11. The server of claim 7, wherein each RF measurement of the RF measurements is determined based on a plurality of response packets received from a corresponding electronic label radio of the plurality of electronic label radios.

12. The server of claim 7, wherein the expected value of the statistic is determined based on an entry in the lookup table for the electronic label radio.

13. A server, comprising:
one or more memories;
one or more transceivers; and
one or more processors communicatively coupled to the one or more memories and the one or more transceivers, the one or more processors, either alone or in combination, configured to:
receive, via the one or more transceivers, from a camera system, one or more images of an electronic label display displaying one or more distinct visual indications;
determine whether a location of the electronic label display estimated based on the one or more images varies from an expected location of the electronic label display by more than a threshold; and
perform one or more validation operations based on a determination that the location of the electronic label display estimated based on the one or more images varies from the expected location of the electronic label display by more than the threshold.

14. The server of claim 13, wherein the one or more distinct visual indications are displayed on the electronic label display based on:
a periodic duty cycle configured by the server;
a trigger from the server;
a periodic duty cycle configured by an electronic label access point associated with the electronic label display;
a trigger from the electronic label access point associated with the electronic label display;
regular operation of the electronic label display; or
any combination thereof.

15. The server of claim 13, wherein the one or more processors configured to determine comprises the one or more processors, either alone or in combination, configured to:
determine a bounding box around the electronic label display in the one or more images; and
determine whether the bounding box varies from the expected location of the electronic label display by more than the threshold.

16. The server of claim 13, wherein the one or more processors, either alone or in combination, are further configured to:
receive, via the one or more transceivers, a plurality of images of a plurality of electronic label displays, including the electronic label display;
receive, via the one or more transceivers, a plurality of radio frequency (RF) measurements associated with the plurality of electronic label displays;
receive, via the one or more transceivers, identifiers of the plurality of electronic label displays; and
generate a lookup table for the plurality of electronic label displays based on the identifiers of the plurality of electronic label displays, the plurality of images, and the plurality of RF measurements.

17. The server of claim 16, wherein an image of each electronic label display of the plurality of electronic label displays is captured at the same time as an RF measurement associated with the each electronic label display is obtained.

18. The server of claim 16, wherein the lookup table includes:
a bounding box indicating a location of each of the plurality of electronic label displays;
location coordinates indicating the location of each of the plurality of electronic label displays;
an image of each of the plurality of electronic label displays displaying a distinct visual indication; or
any combination thereof.

19. The server of claim 16, wherein the expected location of the electronic label display is determined based on an entry in the lookup table for the electronic label display.

20. A method of positioning performed by a server, comprising:
receiving a plurality of radio frequency (RF) measurements of a plurality of beacon signals transmitted by an electronic label radio;
determining whether a statistic of a set of RF measurements of the plurality of RF measurements received over a measurement window varies from an expected value of the statistic by more than a threshold; and
performing one or more validation operations based on a determination that the statistic of the set of RF measurements received over the measurement window varies from the expected value of the statistic by more than the threshold.
